(19) United States
(12) Patent Application Publication
(10) Pub. No.: US 2021/0003151 A1
(43) Pub. Date: Jan. 7, 2021

(54) Hydraulic Pressure Regulator and Method of Use

(71) Applicant: Poseidon Deepwater Solutions LLC, Katy, TX (US)

(72) Inventor: Christopher Phillips, Pattison, TX (US)

(21) Appl. No.: 16/918,483

(22) Filed: Jul. 1, 2020

Related U.S. Application Data
(60) Provisional application No. 62/869,772, filed on Jul. 2, 2019.

(51) Int. Cl. F15B 13/04; E21B 33/035; F15B 1/04

(52) U.S. Cl. CPC F15B 13/0402; E21B 33/06; F15B 1/04; E21B 33/0355

(57) ABSTRACT

A hydraulic pressure regular having a vessel, a body with a difference in diameters along the body, the body including a stem, at least one piston to provide a force on the stem.

### CROSS REFERENCE TO RELATED APPLICATIONS

The present application claims priority to provisional application 62/869,772, filed Jul. 2, 2019, the entirety of which is incorporated by reference.

### STATEMENT REGARDING FEDERALLY SPONSORED RESEARCH OR DEVELOPMENT

None.

### FIELD OF THE DISCLOSURE

Aspects of the disclosure related to a valve in a hydraulic system which regulates downstream pressure to a desired amount, regardless of an upstream supply pressure.

### BACKGROUND

Blowout preventers (“BOPs”) are a safety system used in the recovery of hydrocarbons. BOPs rely on stored energy in the event, of a loss of input power or control to shut off a flow of hydrocarbons, when necessary. This stored energy is typically stored in a component called an accumulator that uses nitrogen or a similar gas as a spring. The pressure within the accumulator may be much higher than the amount of energy needed for completion of BOP functions. When needed, fluid is forced from the accumulator, under pressure, into the system, thus transferring energy.

The fluid forced from the accumulator is used to typically move a piston or other mechanical device in case of emergency. The blowout preventer has many functions and these functions can all require different operational pressures. Thus, the hydraulic energy may be stored at a high pressure but fed through a reducing or regulating valve before it can be used. If such a reduction in not performed damage may occur to the equipment from too high of a hydraulic pressure.

Some conventional valves have been offered which use a sliding mechanism which shifts in proportion to a downstream pressure. This shifting, in turn, pushes on a spring. The spring and this force balance out when the downstream pressure is at a desired value. The spring travel and the physical distances within the sliding mechanism determine the behavior of the valve. These conventional valves cannot be easily adjusted. By changing to a hydraulic spring (which uses a piston to compress nitrogen) the spring can be easily tuned by adding or subtracting gas volume, and the resulting output pressure is very precise.

The regulator system using a hydraulic and nitrogen spring require an additional level of hydraulic circuitry. The system needs a way of remotely adding or subtracting hydraulic pressure to the bottles. This, combined with the additional maintenance points of having two accumulator bottles (one for service and one for subsea operation) have led this style of regulator to fall out of favor in all but the applications requiring remote adjustment or a wide range of adjustability and precision.

There exists a need for a valve, which overcomes all of these operational challenges.

There is a need to provide a valve that provides the same level of control as a hydraulic spring, but without the additional circuitry to adjust the valve.

There is a further need to provide a remote operated valve, a remotely operated vehicle or human to be able to adjust the valve with little to no tools.

There is a further need to provide a method of controlling regulation activities such that, they are cost-effective, durable and able to be implemented on existing installations.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one non-limiting embodiment, a valve is disclosed comprising: a vessel having a bore and at least two ports connected to the bore, a body positioned inside the bore, the body having at least one stem and dual sealing mechanisms against the body, and wherein the body has different diameters along the body to regulate a hydraulic pressure, at least one piston configured to act on a hydraulic pressure, the piston connected to the at least one stem and an arrangement configured to force the body against the hydraulic pressure.

In, one non-limiting embodiment, a method of modulating a pressure within a hydraulic pressure regulator is disclosed comprising: accepting a first pressure into a chamber the hydraulic pressure regulator, the hydraulic pressure regulator having a supply adjustment portion and a relieve adjustment portion, accepting a second pressure into the chamber, moving a carrier against a spring when the second pressure is greater than the first pressure, thereby closing a supply to the hydraulic pressure regulator and thereby opening a vent, thereby venting the second pressure to an exterior environment, and moving a carrier when the second pressure is lesser than the first pressure, thereby opening a supply to the hydraulic pressure regulator, supplying the regulator with a fluid pressure back to the first pressure.

In another non-limiting embodiment, an arrangement is disclosed comprising a valve comprising a relief adjustment portion and a supply adjustment portion, the valve located in a pressure vessel, a bias spring connected between the pressure vessel and the relief adjustment portion, such that a force placed upon the spring from a chamber will trigger a venting of a pressure through a pressure vent when the pressure is larger than a set point value and at least two pistons within the valve, wherein the relief adjustment portion has one piston and the supply adjustment portion has one piston and wherein the piston in the relief adjustment moves to a relief position when pressure within the pressure vessel, exceeds the set point value and wherein the piston in the supply adjustment portion moves to a supply position when pressure in the pressure vessel is below a second set point value.

Other aspects and advantages will become apparent from the following description and the attached claims.

### BRIEF DESCRIPTION OF THE DRAWINGS

In the following detailed description an example embodiment, reference is made to the accompanying drawings, which form a part hereof and in which are shown by way of illustration examples of an example embodiment with which the invention may be practiced. In the drawings and descriptions, like or corresponding parts are marked throughout the specification and drawings with the same reference numerals. The drawings are not necessarily to scale. Certain features of the disclosure may be shown exaggerated in scale or in somewhat symbolic or schematic form and some details of conventional elements may not be shown in the interest of clarity and conciseness.

FIG. 1 is a side longitudinal center sectional view of a typical mechanical spring regulator in the prior art.

FIG. 2 is a flow chart of the regulating valve in relation to a system.

FIG. 3 is a detailed cross-sectional view of a current embodiment of the disclosure.

FIG. 4 is a detailed cross-sectional view of the supply center body.

FIG. 5 is a detailed cross-sectional view of the release center body.

FIG. 6 is a simplified cross-sectional view of a valve showing the various pressure contained areas.

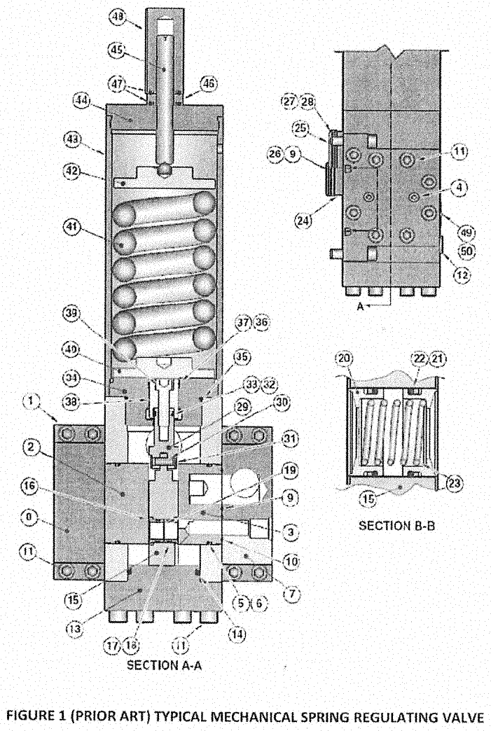

To facilitate understanding, identical reference numerals have been used, where possible, to designate identical elements that are common to the figures (“FIGS”). It is contemplated that elements disclosed, in one embodiment may be beneficially utilized on, other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure, Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and shall not be considered to be an element or limitation of the claims except where explicitly recited in a claim.

Although the terms first, second, third, etc., may be used herein to describe various elements, components, regions, layers, and/or sections, these elements, components, regions, layers and/or sections should not be limited by these terms. These terms may be only used to distinguish one element, components, region, layer or section from another region, layer or section. Terms such as “first”, “second”, and other numerical terms when used herein do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged, to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower” “upwardly” and “downwardly”, and other like terms indicating relative positions above or below a given point are used in this description to more clearly describe certain embodiments.

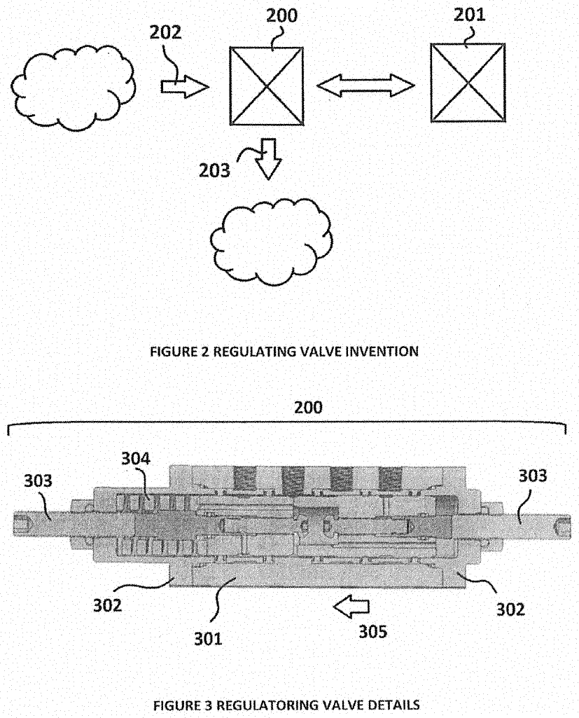

Referring to FIG. 2, aspects of the disclosure are illustrated. In one non-limiting embodiment of the disclosure, a valve 200 is provided to supply hydraulic fluid to a system 201. The valve 200 is supplied pressure 202 to the valve 200 at a pressure higher than is needed. The valve 200 will allow fluid into the system 201 until the setting of pressure has been achieved. At that time, the valve 200 will close and not allow any more fluid to enter the system 201, thereby maintaining the set pressure of the system 201. If the pressure exceeds a set point of the system, the valve 200 will allow system fluid to vent 203 and thereby lower the pressure of the system 201. As is illustrated, pressure may be transferred back and forth from the valve 200 to the system 201. Thus the valve 200 may act as a safeguard for over pressurization of the system 201.

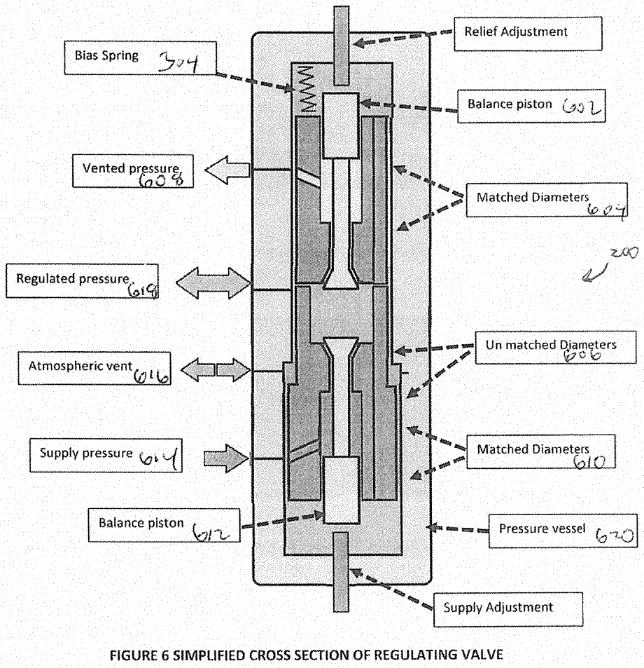

Referring to FIG. 3, the valve 200 is shown in more detail. The valve 200 has a body 301 with end caps 302 thereby defining a pressure vessel. The end caps 302 typically contain an adjustable device 303 to define the internal length of the pressure vessel. The distance internal to the pressure vessel defines the pressure at which the regulator opens to supply or opens to vent pressure, as described above. An arrangement 304, such as a spring, may provide a bias to the valve 200 which is overcome by hydraulic force 305 acting on a portion of the valve diameters. Such a configuration is provided in FIG. 6.

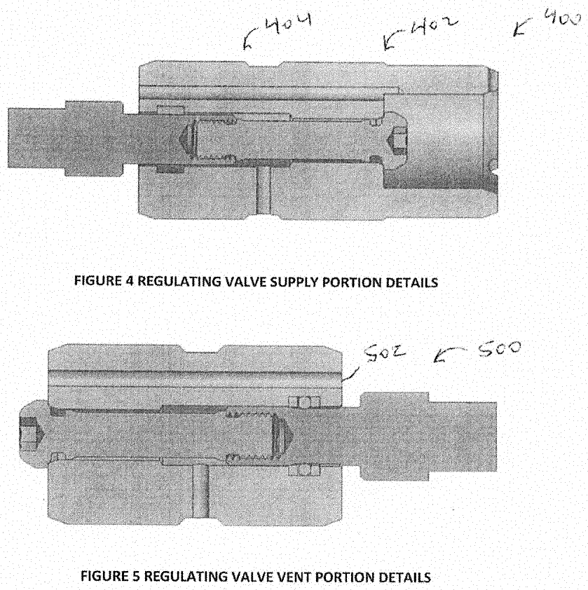

The valve 200 has two working portions; a supply valve 400 and a relief valve 500. The supply valve 400 is presented in FIG. 4 and the relief valve 500 in FIG. 5. The supply valve 400 has two diameters 402, 404 which have seals. These two diameters 402, 404 provide a hydraulic bias when pressure is applied. The bias is directly counteracted by a mechanical spring 304, as illustrated in FIG. 3. There are other methods of providing this bias, and the example embodiment should be considered non-limiting. Some other methods include beams, bars, extension springs and mechanical deflection of material. Other springs include nitrogen springs or similar gas, rubber or elastomeric, trapped gas bubbles in an elastomer, or gas dissolved in a fluid.

The other working portion, the relief valve 500, the relief function, is pressure balanced on its outer diameter. This provides nearly zero resistance to movement as the pressure increases. A communication hole 502 is drilled through the core to allow the pressure to act on both sides of the valve 500. In the present configuration, the bias spring is contacting one side of the carrier and the supply carrier is contacting the other side. A feature is provided to allow fluid flow from between the supply and relief carriers. This is the regulated output of the valve 500.

In both functions, there is a central sealing element. The stem has the ability to seal in both directions. This is important as the valve may experience pressure from any direction when in use. The stem is given a bias force hydraulically depending on its intended sealing direction.

There is, a bias piston screwed onto the stem of both functions. The bias piston has a sealing diameter which closely matches the sealing diameter of the stem. If the piston diameter is slightly smaller, the stem will open when exposed to internal pressure and close when exposed to external pressure. The same is true if the diameter is slightly larger than the stem diameter. The stem will close when presented internal pressure and open when exposed to external pressure.

When hydraulic pressure is provided, the pressure tends to close the supply stem. The entire valve 200 is biased due to the spring 304 however to strike the supply stem “open”. Thus, the valve flows hydraulic fluid through the supply stem and into the common regulated port. When this port increases in pressure, the resultant force on the supply carrier pushes the spring 304 and compresses it. By compressing the spring 304, the supply stem is allowed to close slightly. By continuing to compress the spring 304, eventually, the supply stem is allowed to fully seat and by internal bias, continues to seal against incoming pressure. The system now is at a “set point”. If the system “connected to the regulated port” exceeds the set point, the pressure continues to shift the carriers against the spring 304 and compresses. At a certain pressure, the relief stem is triggered open. By releasing pressure through the relief stem, the system pressure will reduce which in turn releases some force on the spring 304. With less force on the spring 304, the carriers will return to a “central” position where no stems are triggered. The relief stem has a slight bias to remain closed with external pressure all around it.

The distance traveled by the carriers and relationship to the spring force determine the adjustability of the valve 200. Typically, a regulator type valve has a fixed distance traveled before the two functions occur. This distance is determined by features internal to the regulator and sealing surfaces, seal carriers, etc. Manufacturing tolerances and variability in the spring 304 can greatly affect this distance, specifically when dealing with high pressures and forces. The distance is very slight and is desired to be as short as possible to enable a fast reacting valve. Therefore, it is desirable to have an adjustment for each one independent of one another for maximum precision. Typically, a valve 200 has one setting adjustment for the spring compression. The valve 200 acts in much the same way where hydraulic pressure forces the carrier against the spring 304. Once traveled, the valve 200 closes supply and then eventually opens a relief. An increase in friction can affect the setting by as much as 20%.

Another benefit of this design is that the working portions are fairly low mass. They can react quickly and have a high natural frequency. They are resistant to entering an oscillation accordingly. In larger regulators, there is a high amount of mass in both the working seals as well as the spring. In addition, the forces acting on the spring are very large. This is due to unbalanced areas. When a regulator of that type gets into an oscillation, the sealing mechanisms dictate that it will experience widely varying amounts of seal friction. Recall that seal friction makes up a large portion of the force within that type of regulator and if it is varying, the regular will have a hard time reaching a stable condition. This instability can cause issues with the downstream hydraulic system as well as internal to the regulator. Premature failure can occur very quickly if an oscillation begins.

Referring to FIG. 6, a simplified cross-section of the regulating valve 200 is illustrated. A bias spring 304 is provided to provide a biasing force on the relief adjustment section of the valve 200. On the relief adjustment side, a balance piston 602 is provided that moves from a closed position to an open position. A matched diameter 604 portion is provided on the relief adjustment side, compared to unmatched diameters 606 on the supply adjustment side, Pressure may be vented to a port 608 on the relief adjustment side.

Referring further to FIG. 6, the supply adjustment side also has a matched diameter section 610 as well as a balance piston 612, A supply for pressure may enter the supply adjustment through a supply pressure port 614. An atmospheric vent 616 is also provided for venting to an external environment. The atmospheric vent 616 as well as the vented pressure 608 as well as a regulated pressure 618 section may penetrate the pressure vessel 620.

As will be understood, a control system may also be used to control actions of the valve 200. The control system may include air or pneumatics, hydraulic pressure, grease, an electrical solenoid and electric motor, a driveshaft or levers.

In one-nonlimiting embodiment, a valve is disclosed comprising: a vessel having a bore and at least two ports connected to the bore, a body positioned inside the bore, the body having at least one stem and dual sealing mechanisms against the body, and wherein the body has different diameters along the body to regulate a hydraulic pressure, at least one piston configured to act on a hydraulic pressure, the piston connected to the at least one stem and an arrangement configured to force the body against the hydraulic pressure.

In one non-limiting embodiment, the valve may be configured wherein the bore is a central bore.

In another non-limiting embodiment, the valve may be configured wherein the body has at least two parts.

In another non-limiting embodiment, the valve may be configured wherein, a first part of the body provides hydraulic pressure into a chamber and a section part of the body is configured to allow pressure to exit the chamber.

In another non-limiting embodiment, the valve may further comprise a screw thread configured to provide a distance traveled before the stem reaches an open position.

In another non-limiting embodiment, the valve may be configured wherein the arrangement is configured as a coil spring.

In another non-limiting embodiment, the valve may be configured wherein the arrangement includes a washer.

In another non-limiting embodiment, the valve may be configured wherein the arrangement is configured to provide a variable force.

In another non-limiting embodiment, the valve may be configured wherein the arrangement produces the variable force through a gas contained in at least one of a liquid, an elastomer, a rigid pressure vessel and a semi-rigid pressure vessel.

In one-non-limiting embodiment, a method of modulating a pressure within a hydraulic pressure regulator is disclosed comprising: accepting a first pressure into a chamber the hydraulic pressure regulator, the hydraulic pressure regulator having a supply adjustment portion and a relieve adjustment portion, accepting a second pressure into the chamber, moving a carrier against a spring when the second pressure is greater than the first pressure, thereby closing a supply to the hydraulic pressure regulator and thereby opening a vent, thereby venting the second pressure to an exterior environment, and moving a carrier when the second pressure is lesser than the first pressure, thereby opening a supply to the hydraulic pressure regulator, supplying the regulator with a fluid pressure back to the first pressure.

In another non-limiting embodiment, an arrangement is disclosed comprising a valve comprising a relief adjustment portion and a supply adjustment portion, the valve located in a pressure vessel, a bias spring connected between the pressure vessel and the relief adjustment portion, such that a force placed upon the spring from a chamber will trigger a venting of a pressure through a pressure vent when the pressure is larger than a set point value and at least two pistons within the valve, wherein the relief adjustment portion has one piston and the supply adjustment portion has one piston and wherein the piston in the relief adjustment moves to a relief position when pressure within the pressure vessel exceeds the set point value and wherein the piston in the supply adjustment portion moves to a supply position when pressure in the pressure vessel is below a second set point value.

In another non-limiting embodiment, the arrangement may further comprise a control system to operate the valve.

In another non-limiting embodiment, the arrangement may be configured wherein the control system uses one of air or pneumatics.

In another non-limiting embodiment, the arrangement may be configured wherein the control system uses hydraulic force.

In another non-limiting embodiment, the arrangement may be configured wherein the control system uses grease.

In another non-limiting embodiment, the arrangement may be configured wherein the control system uses at least one electric solenoid.

In another nonlimiting embodiment, the arrangement may be configured wherein the control system uses at least one electric motor.

In another non-limiting embodiment, the arrangement may be configured wherein the control system uses one of a drive shaft, a mechanical rotary system and at least one lever.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A valve, comprising:
a vessel having a bore and at least two ports connected to the bore;
a body positioned inside the bore, the body having at least one stem and dual sealing mechanisms against the body, and wherein the body has different diameters along the body to regulate a hydraulic pressure;
at least, one piston configured to act on a hydraulic pressure, the piston connected to the at least one stem; and
an arrangement configured to force the body against the hydraulic pressure.

2. The valve according to claim 1, wherein the bore is a central bore.

3. The valve according to claim 1, wherein the body has at least two parts.

4. The valve according to claim 2, wherein a first part of the body provides hydraulic pressure into a chamber and a section part of the body is configured to allow pressure to exit the chamber.

5. The valve according to claim 1, further comprising a screw thread configured to provide a distance traveled before the stem reaches an open position.

6. The valve according to claim 1, wherein the arrangement is configured as a coil staging.

7. The valve according to claim 6, wherein the arrangement includes a washer.

8. The valve according to claim 1, wherein the arrangement is configured to provide a variable force.

9. The valve according to claim 8, wherein the arrangement produces the variable force through a gas contained in at least one of a liquid, an elastomer, a rigid pressure vessel and a semi-rigid pressure vessel.

10. A method of modulating a pressure within a hydraulic pressure regulator, comprising:
accepting a first pressure into a chamber the hydraulic pressure regulator, the hydraulic pressure regulator having a supply adjustment portion and a relieve adjustment portion;
accepting a second pressure into the chamber;
moving a carrier against a spring when the second pressure is greater than the first pressure, thereby closing a supply to the hydraulic pressure regulator and thereby opening a vent, thereby venting the second pressure to an exterior environment; and
moving a carrier when the second pressure is lesser than the first pressure, thereby opening a supply to the hydraulic pressure regulator, supplying the regulator with a fluid pressure back to the first pressure.

11. The method according to claim 10, wherein at least one piston is moved during the moving of the carrier.

12. The method according to claim 11, wherein the et least one piston is two pistons.

13. An arrangement, comprising:
a valve comprising a relief adjustment portion and a supply adjustment portion, the valve located in a pressure vessel;
a bias spring connected between the pressure vessel and the relief adjustment portion, such that a force placed upon the spring from, a chamber will trigger a venting of a pressure through a pressure vent when the pressure is larger than a set point value; and
at least two pistons within the valve, wherein the relief adjustment portion has one piston and the supply adjustment portion has one piston and wherein the piston in the relief adjustment moves to a relief position when pressure within the pressure vessel exceeds the set point value and wherein the piston in the supply adjustment portion moves to a supply position when pressure in the pressure vessel is below a second set point value.

14. The arrangement according to claim 13, further comprising:
a control system to operate the valve.

15. The arrangement according to claim 14, wherein the control system uses one of air or pneumatics.

16. The arrangement according to claim 14, wherein the control system uses hydraulic force.

17. The arrangement according to claim 14, wherein the control system uses grease.

18. The arrangement according to claim 14, wherein the control system uses least, one electric solenoid.

19. The arrangement according to claim 14, wherein the control system uses at least one electric motor.

20. The arrangement according to claim 14, wherein the control system uses one of a drive shaft, a mechanical rotary system and at least one lever.
